(19) United States
(12) Patent Application Publication
(10) Pub. No.: US 2016/0094951 A1
(43) Pub. Date: Mar. 31, 2016

(54) WI-FI FINGERPRINT LOCATION DATABASE CREATION AND UPDATE FROM CROWD SOURCED DATA

(71) Applicants: Shao-Wen Yang, Hillsboro, OR (US); Lei Yang, Hillsboro, OR (US); Xue Yang, Arcadia, CA (US)

(72) Inventors: Shao-Wen Yang, Hillsboro, OR (US); Lei Yang, Hillsboro, OR (US); Xue Yang, Arcadia, CA (US)

(21) Appl. No.: 14/497,832

(22) Filed: Sep. 26, 2014

(51) Int. Cl. H04W 4/02

(52) U.S. Cl. CPC H04W 4/028

(57) ABSTRACT

Disclosed herein are techniques to update a wireless fingerprint location database. According to such techniques, an update server updates a location database based on trajectories of a number of computing devices. The trajectories corresponding to sensor data collected by the computing devices, the sensor data including at least indication of RSSIs and inertial measurements. The RSSIs corresponding to wireless APs within an interior of a structure and represented in the location database.

### TECHNICAL FIELD

Embodiments described herein generally relate to wireless signal location mapping.

### BACKGROUND

Computing devices may provide the ability to track a location within an indoor space through receiving wireless signals from multiple access points and deriving a current location from matching fingerprints of the wireless signals based on a location database. In general, wireless signal fingerprint matching may enable robust indoor positioning by providing global location estimations with bounded errors. Additionally, it does not require priori location estimates to initialize the estimation.

However, such location techniques require on-site deployments to build a location database of the indoor environment. Changes in the indoor environment (e.g., movement of furniture, re-arrangement of modular walls, or the like) as well as changes to the location of wireless access points can lead to an outdated location database. As will be appreciated, the correctness of the location database directly affects the accuracy of locations derived from the location database. Accordingly, a repeat of the initial on-site deployment may be necessary to update the database each time changes to the indoor environment are made.

The present disclosure is directed to updating a location database without necessitating another on-site deployment.

### BRIEF DESCRIPTION OF THE DRAWINGS

FIG. 1 illustrates one embodiment of a Wi-Fi fingerprint location database update system.

FIG. 2 illustrates a portion of the system of FIG. 1.

FIG. 3 illustrates an embodiment of sensor data used in the system of FIG. 1.

FIGS. 4-5 illustrate portions of the system of FIG. 1.

FIGS. 6-7 illustrates logic flows for updating a Wi-Fi fingerprint location database.

FIG. 8 illustrates one embodiment of a storage medium.

FIG. 9 illustrates an embodiment of a wireless network.

### DETAILED DESCRIPTION

Examples disclosed herein are generally directed to adapting a location database of an indoor environment to changes to the indoor environment. For example, a location database may be updated to account for changes to the locations of wireless access points (APs) within the indoor environment. In general, the location database is updated based on “crowd sourced” data from computing devices utilizing the location database.

Said differently, while a computing device (e.g., a smart phone, a laptop, a tablet computer, a wearable computing device, or the like) utilizes an existing location database to determine its current position, the same computing device may also contribute sensor data (e.g., wireless signal data, inertial sensor data, magnetic sensor data, or the like) to a location database update server. The location database update server may then update a location database for the indoor environment based on sensor data collected from multiple such computing devices. In particular, changes to the wireless APs within the indoor environment may be determined from the sensor data collected from multiple computing devices, such as, for example computing devices using the location database to determine their position within the indoor environment.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Reference is made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

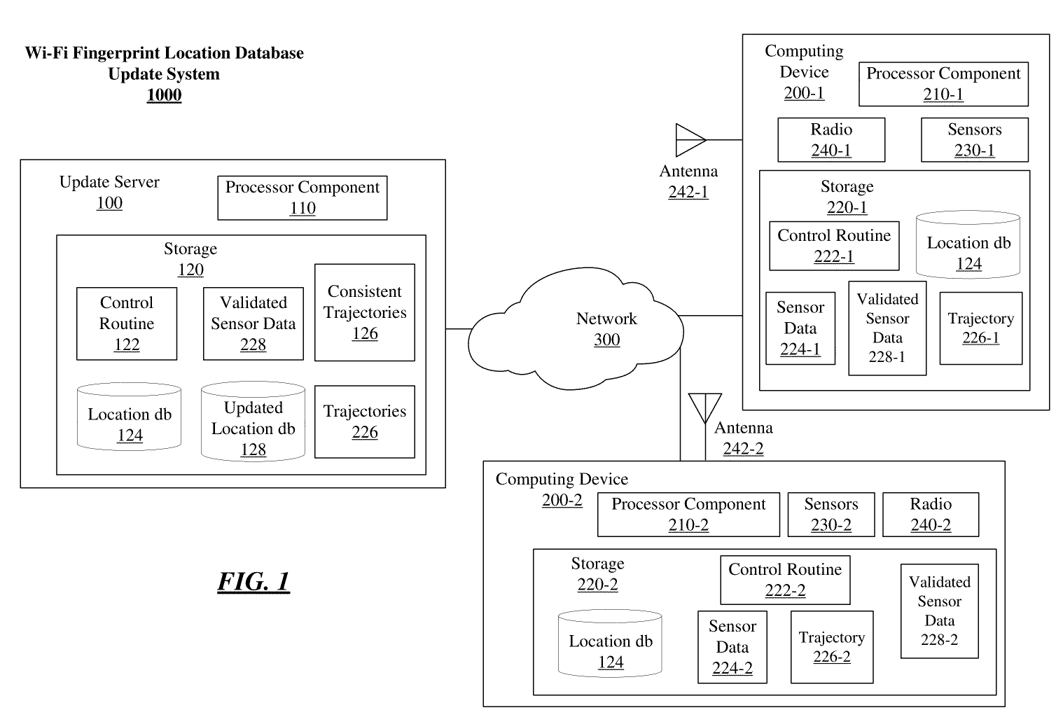

FIG. 1 is a block diagram of a Wi-Fi fingerprint location database update system 1000. It is important to note, various examples discussed herein reference location databases utilizing “Wi-Fi” fingerprints. However, the present disclosure may be implemented to update location databases that map locations based on other types of wireless fingerprints. For example, location databases for Ultra Wideband (UWB) wireless signals, ZigBee wireless signals, Bluetooth wireless signals, WiGig wireless signals, acoustic signals, or the like, may be updated based on the teachings of the present disclosure. As such, the examples are not to be limited in this context.

Furthermore, it is important to note, as will be apparent from the present disclosure, that the system 1000 is configured to update a location database based on wireless signals and inertial measurements. In particular, the system 1000 includes an update server 100 and multiple computing devices (e.g., “client devices”) 200-a, where “a” is a positive integer. It is noted, that a limited number of computing devices 200-a are shown for purposes of clarity. Specifically, computing devices 200-1 and 100-2 are shown. However, it is to be appreciated, that any number of computing devices 200-a may be implemented. For example, in practice, the system 1000 may accommodate any number computing devices 200-a and will typically be operated with many more than depicted in the figures.

In general, the server 100 is configured to update a location database (e.g., the location database 124) based on sensor data from the computing devices 200-a. In particular, the computing devices 200-a generates sensor data by repeatedly (e.g., on a fixed period, or the like) receiving samples including at least a signal indication corresponding to a wireless signal and an inertial measurement. In general, the signal indication may be any of a variety of indications of the signal (e.g., strength, quality, direction, or the like). For example, in some embodiments, the signal indication may be a radio signal strength indication (RSSI) corresponding to a wireless signal. In some embodiments, the signal indication may be a signal to noise ratio corresponding to a wireless signal. It is to be appreciated, that although the signal indication may be any of a variety of signal indications, an RSSI signal indication is used throughout the present disclosure for purposes of clarity of presentation in discussing the examples.

Accordingly, these samples (e.g., the RSSIs, inertial measurements, etc.) may be received a number of times (e.g., on a fixed period, such as, for example, 30 minutes, or the like) and communicated to the server 100 by the computing devices 200-a as sensor data. The server 100 uses such sensor data to update the location database 124 to account for changes to the location of wireless APs in the indoor environment represented by the location database 124.

As will be appreciated, the sensor data collected by the computing devices 200-a may be uncontrolled and the quality of the data may vary. As such, in order to prevent the database 124 from being contaminated by poor quality data while allowing good quality data to be used to update the database 124, the system 1000 is configured to align the sensor data with the existing database to form trajectories and to filter the data quality based on the aligned trajectories. By translating the motion corresponding to the received sensor data into trajectories, spatial correlations between consecutive samples collected during one sampling event are leveraged. It is to be appreciated, that the operations described herein for aligning the sensor data with the location database to form trajectories and to filter the data based on the trajectories can be performed either by the computing devices 200-a, by the update server 100, or some combination of the two. Which portions of the system 1000 are responsible for the generation of the trajectories, validation and/or filtering of the data can be implementation dependent. For example, it may depend upon the computing power available on the computing devices 200-a, on the bandwidth available to communicate between the computing devices 200-a and the update server, or the like.

The server 100 includes a processing component 110 and storage 120. The storage 120 may store one or more of a control routine 122, location database 124, validated sensor data 228, trajectories 226, consistent trajectories 126, and an updated location database 128. In general, the server 100 can be any of a variety of computing devices, such as, for example, a laptop, a desktop, a server, a cloud computing system, or the like.

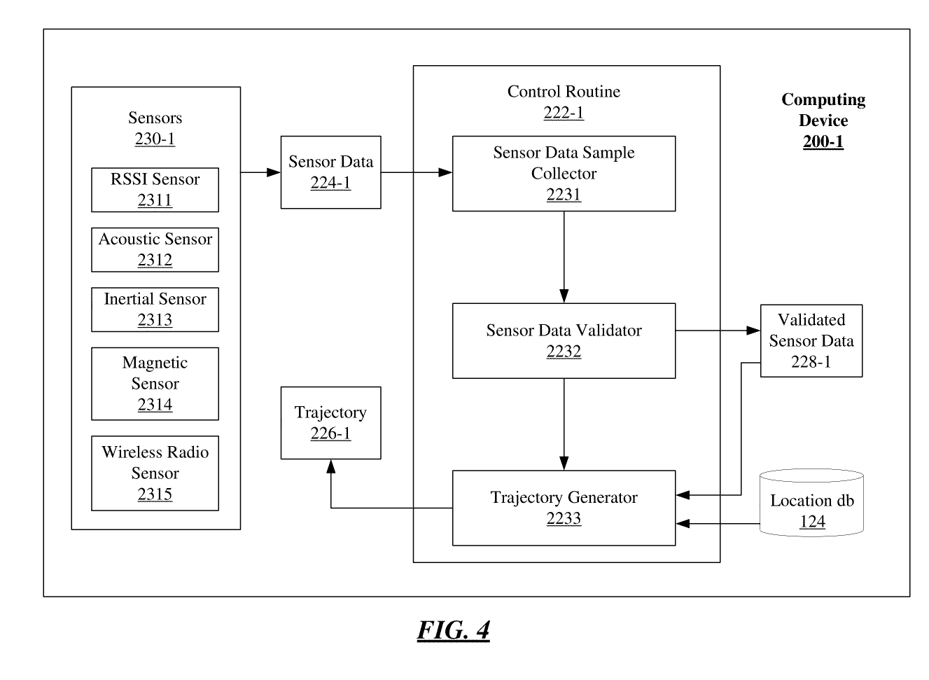

Each of the computing devices 200-a includes a processor component 210-a, storage 220-a, sensors 230-a, a radio 240-a, and an antenna (or antenna array) 242-a. The storage 220-a may store one or more of a control routine 222-a, sensor data 224-a, location, validated sensor data 228-a, trajectory 224-a, and the location database 124. In general, the computing devices 200-a may be any of a variety of computing devices comprising sensors (e.g., refer to FIG. 4) configured to repeatedly sense or measure at least an RSSI for a wireless AP and an inertial measurement. For example, without limitation, the computing devise 200-a may be one or more of a laptop computer, a wearable computing device, a tablet computer, a smart phone, or the like.

As depicted, the server 100 and the computing devices 200-a may exchange signals conveying sensor data information, location database information, and trajectory information through network 300. In various embodiments, the network 300 may be a single network possibly limited to extending within a single building or other relatively limited area, a combination of connected networks possibly extending a considerable distance, and/or may include the Internet. Thus, the network 300 may be based on any of a variety (or combination) of communications technologies by which signals may be exchanged, including without limitation, wired technologies employing electrically and/or optically conductive cabling, and wireless technologies employing infrared, radio frequency or other forms of wireless transmission. Furthermore, although the network 300 is shown as a wired network, it may in some examples be a wireless network. In particular, as each of the computing devices 200-a is configured to sense wireless signals, the network 300 may, in many implementations, be a wireless network (e.g., refer to FIG. 9).

During operation, each of the computing devices 200-a is configured to generate sensor data 224-a. In particular, the control routine 222-a includes a sequence of instructions operative on the processing component 210-a in its role as a processing component to implement logic, features, or functions. In executing the control routine 222-a, the processor component 210-a generates the sensor data 224-a. For example, the computing devices 200-a can generate sensor data by periodically receiving samples from the sensors 230. In particular, each of the sensor samples includes at least an RSSI indicator for one or more wireless APs. Furthermore, each of the sensor samples includes an inertial measurement.

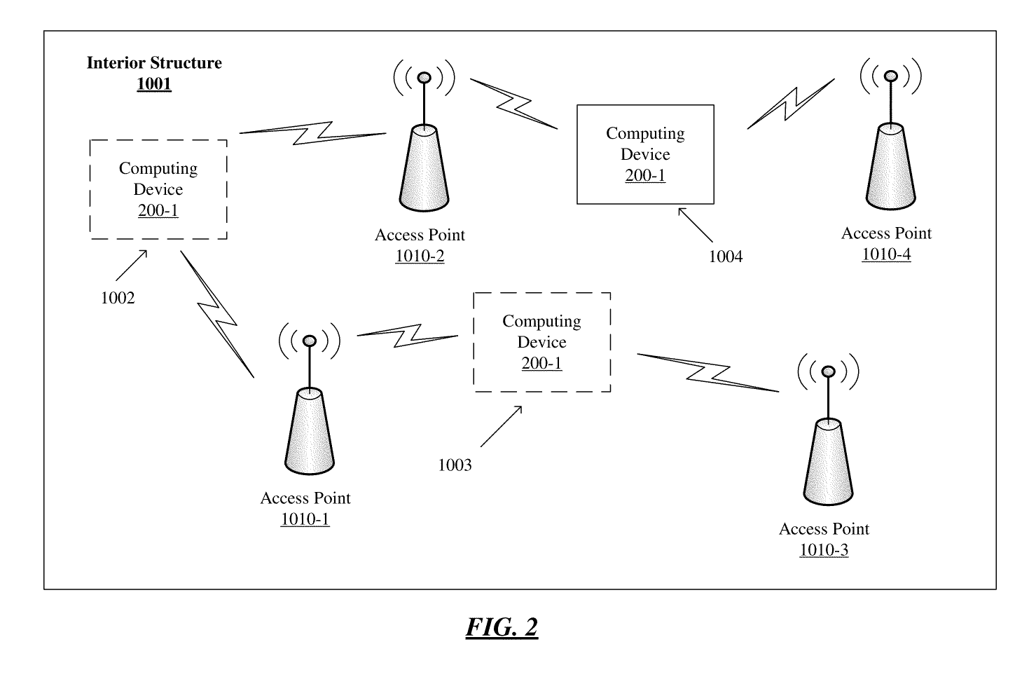

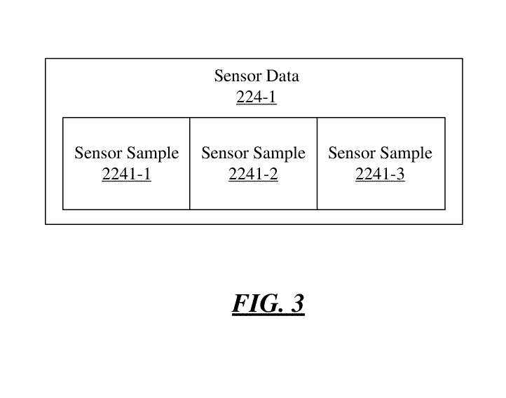

As an example, FIGS. 2-3 illustrate the computing device 200-1 and associated sensor data 224-1 collected as the computing device 200-1 is moved throughout an interior of a structure 1001. More particularly, referring to FIG. 2, the device 200-1 may repeatedly (e.g., on a fixed period, or the like) receive sensor samples, including at least an indication of an RSSI for wireless APs 1010 and an inertial measurement. In particular, the computing device 200-1 is shown at a first time and location 1002 receiving wireless signals (e.g., via antenna 242-1 and radio 240-1) from the APs 1010-1 and 1010-2; at a second time and location 1003 receiving wireless signals (e.g., via antenna 242-1 and radio 240-1) from the APs 1010-1 and 1010-3; and at a third time and location 1004 receiving wireless signals (e.g., via antenna 242-1 and radio 240-1) from the APs 1010-2 and 1010-4. Accordingly, the computing device 200-1 may, receive sensor samples for these respective time periods, including an indication of the RSSIs for the respective APs to which the computing device 200-1 is receiving wireless signals and an inertial measurement. In particular, as illustrated in FIG. 3, the sensor data 224-1 may include samples 2241-1, 2241-2, and 2241-3 corresponding to the samples received at each of the time periods and locations 1002, 1003, and 1004.

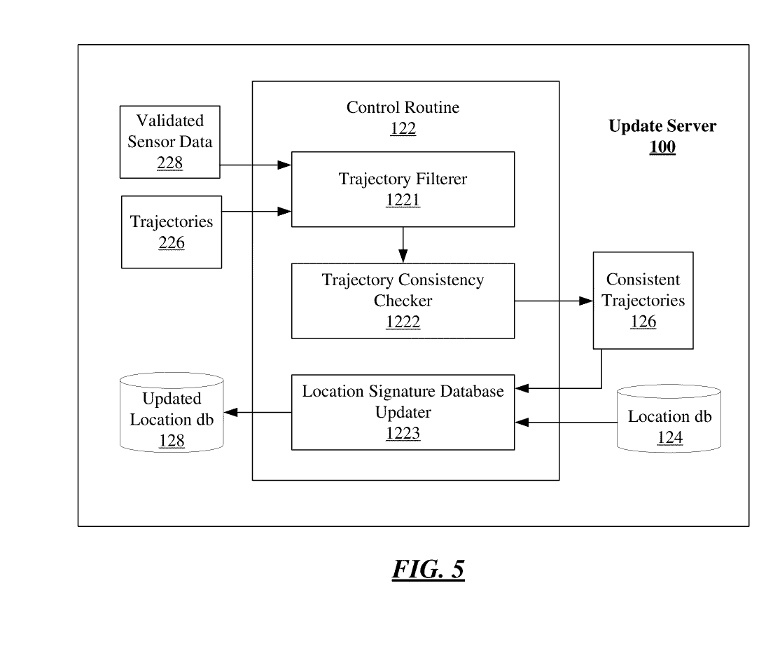

Returning to FIG. 1, in the computing devices 200-a, in executing the control routine 222-a, the processing component 210-a validates the sensor data 224-a and generate validated sensor data 228-a. More specifically, the processing component 210-a may identify ones of the received samples (e.g., the samples corresponding the sensor data 224-a) to be used to update the location database 124. In particular, the processor component 210-a may be configured to disqualify some of the samples from the sensor data 224-a (e.g., refer to FIGS. 4-5). As such, the communication overhead necessary to convey the sensor data 224-a to the update server 100 may be reduced. Additionally, the quality of the sensor data 224-a may be increased.

In executing the control routine 222-a, the processor component 210-a generates sensor data 224-a. For example, as explained, the processor component 210-a receives samples (e.g., including an RSSI and inertial measurement) and generates the sensor data 224-a from the samples Furthermore, in executing the control routine 222-a, the processor component 210-a generates a trajectory 226-a. In particular, the computing device 200-a can generate a trajectory 226-a based on the sensor data 224-a and the location database 124. As will be appreciated, a variety of techniques for generating trajectories through an interior of a structure based on a wireless fingerprint (e.g., RSSIs) as well as other sensor data exist. The present disclosure can be implemented using any of these various techniques.

It is important to note, although the present disclosure illustrates each of the computing devices 200-a validating the sensor data 224-a generating the trajectories 226-a, some examples, may provide that the server 100 can validate the sensor data and/or generate the trajectories 226. More specifically, the computing devices 200-a may be configured to communicate the sensor data 224-a to the server 100. The server 100 may then be configured to generate trajectories 226 from the sensor data 224.

In the server 100, the control routine 122 includes a sequence of instructions operative on the processor component 110 in its role as a main processor component to implement logic, features, or functions. In executing the control routine 122, the processor component 110 receives validated sensor data 228 (e.g., the validated sensor data 228-1, 228-2, etc.) from the computing devices 200-a. Additionally, the processor component may receive trajectories 226 from the computing devices 200-a. The server 100 is configured to generate an updated location database 128 based on the received validated sensor data 228 and the trajectories 226. In general, the processor component 110 identifies a set of consistent trajectories 126 from the validated sensor data 228 and/or trajectories 226. The processor 110 generates the updated location database 128 from the set of consistent trajectories.

In some examples, the consistent trajectories 126 are the trajectories 226 that are temporally consistent. More specifically, the consistent trajectories 126 are those trajectories 226 with RSSIs that occur within a time window and within a threshold range of each other and where the difference between the identified RSSIs corresponding to the same wireless access point is less than a threshold level.

In some examples, the consistent trajectories 126 are those trajectories 226 that are spatially consistent. More specifically, the consistent trajectories 126 are those trajectories 226 with RSSIs that occur within a threshold time of each other and within a threshold distance of each other and where the difference between the identified RSSIs corresponding to the same wireless access point is less than a threshold level.

In executing the control routine 122, the processing component 110 may determine whether the trajectories 226 are consistent with the interior of the structure and to filter the trajectories 226 based on the determination. More specifically, the processing component 110 may determine whether ones of the trajectories 226 are consistent with known pathways (e.g., locations of walls, or the like) within the interior of the structure.

In executing the control routine 122, the processing component 110 may determine whether a velocity of the trajectories 226 is less than a threshold velocity and to filter the trajectories 226 based on the determination.

In executing the control routine 122, the processing component 110 may determine whether an acceleration of the trajectories 226 is less than a threshold acceleration and filter the trajectories 226 based on the determination.

In executing the control routine 122, the processing component 110 may identify ones of the plurality of wireless APs represented in the sensor data 224 that are inconsistent with the location database 124. In particular, the processing component 110 may determine whether the temporal and spatial continuity between the wireless APs represented in the consistent trajectories 126 and the location database 124 is above a threshold level. Additionally, the processing component 110 may remove ones of the wireless APs from the location database 124 based on the determination that the temporal and/or spatial consistency is not above the threshold level. Furthermore, the processing component 110 generates the updated location database 128 from the location database 124 (e.g., the location database 124 without the inconsistent wireless APs) and the consistent trajectories. For example, the processing component 110 may apply a simultaneous localization and mapping (SLAM) algorithm to generate the updated location database 128 from the location database 124 and the consistent trajectories 126.

In various embodiments, the processor component 110 and/or the processor components 210-a may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked. Additionally, one or more of the processor components, and particularly the processor components 210-a, may be an application specific integrated circuit (ASIC), a baseband processor, or in general, any processing component or circuit configured to execute the control routine.

In various embodiments, the storage 120 and/or the storages 220-a may be based on any of a wide variety of information storage technologies, possibly including volatile technologies requiring the uninterrupted provision of electric power, and possibly including technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array).

FIGS. 4-5 are block diagrams of portions of an embodiment of the Wi-Fi fingerprint location database update system 1000 of FIG. 1. In general, FIGS. 4-5 illustrate aspects of the operation of the system 1000. In particular, FIG. 4 illustrates an embodiment of the computing device 200-1 configured to generate the sensor data 224-1 and the trajectory 226-1 while FIG. 5 illustrates an embodiment of the update server 100 configured to update the location database 124 based on the sensor data 224 and the trajectories 226. It is worthy to note that the computing devices 200-a shown in FIG. 1 may have the same or similar features to the computing device 200-1 depicted in FIG. 4.

In various embodiments, the control routine 122 and/or the control routines 222-a (e.g., the control routine 222-1 shown in FIG. 4) may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor component 110 and/or 210-a. Where one or more device drivers are included, those device drivers may provide support for any of a variety of other components, whether hardware or software components, of the server 100 and/or computing devices 200-a.

Turning more specifically to FIG. 4, the computing device 200-1 includes sensors 230-1. In various examples, the computing device may include one or more of an RSSI sensor 2311, an acoustic sensor 2312, an inertial sensor 2313, and a magnetic sensor 2314. The control routine 222-1 includes a sensor data sample collector 2231, a sensor data validator 2232, and a trajectory generator 2233.

In general, the control routine 222-1 receives periodic samples from sensors 230-1 (e.g., as the computing device 200-1 is carried through an interior of a structure) as sensor data 224-1. The control routine 222-1 validates the sensor data 224-1 and generates trajectories 226-1 from the validated sensor data 228-1 and the location database 124. The control routine 222-1 also communicates the validated sensor data 228-1 and the trajectories 226-1 to the update server 100.

In particular, the sensor data sample collector 2231 repeatedly receives signals from sensors 230-1 including indications of at least an RSSI corresponding to a wireless AP (e.g., the wireless APs 1010 shown in FIG. 2) and an inertial measurement. In some examples, the sensor data sample collector 2231 may receive samples (e.g., sensor samples 2241-a shown in FIG. 3, or the like) every 15 to 45 minutes. In some examples, the inertial measurement may correspond to signals received from the inertial sensor to indicate a movement or position of the computing device 200-1. For example, the inertial sensor 2313 may include one or more of an accelerometer, a gyroscope, or the like configured to output signals including an indication of a movement or relative movement of the computing device 200-1. Additionally, the sensor data 224-1 may include acoustic measurements, magnetic measurements, or other sensor output used to determine a location of the computing device 200-1 from the location database 124.

It is noted, that a benefit of receiving samples (e.g., 2241-a) including an indication of RSSIs as well as inertial measurements can help establish tighter spatial correlation between consecutive samples. More specifically, assume the sensor data 224-1 comprises 6 consecutive samples, with each sample including one or more RSSIs and an inertial measurement. Due to the consecutive nature of the RSSIs and the inertial measurements, the trajectory 226-1 corresponding to the sensor data 224-1 can be generated. In particular, the trajectory 226-1 has a spatial correlation of sensor samples 2241-a that comprise the sensor data 224-1.

The sensor data validator 2232 may be configured to preliminarily screen the sensor data 224-1. In particular, the sensor data validator 2232 may be configured to disqualify obviously poor quality samples from the sensor data 224-1. In some implementations, the sensor data validator 2232 can, based on the types of sensors used to collect the sample, validate the sample based on a number of predetermined criteria. For example, RSSIs are not reliable when the signal strength reading is very high (e.g., due to antenna saturation) or very low (e.g., due to lower signal to noise ratio. As such, the sensor data validator 2232 may validate those samples with an RSSI in a specific range (e.g., −20 to −90 dBm, or the like) and may remove RSSI readings that fall outside the specific range from the sensor data 224-1. As another example, the sensor data validator 2232 may validate inertial readings (e.g., from an accelerometer, gyroscope, or the like) based on constraints corresponding to possible human motion. In particular, the sensor data validator 2232 may validate those samples where inertial measurements indicate specific rates of movement that fall within a range of possible human motion and may remove those inertial measurements that fall outside the specific rates. As a particular example, the sensor data validator 2232 may disqualify inertial measurements from a gyroscope that indicate a rotation rate larger than 500 degrees/second.

As will be appreciated, by disqualifying obviously poor quality sensor samples, the computation overhead of aligning the sensor data with the location database and communicating sensor data and/or trajectories between the computing devices 200-a and the update server 100 may be reduced.

The trajectory generator 2233 may be configured to generate the trajectories 226-1 from the validated sensor data 228-1 and the location database 124. In general, the trajectory generator 2233 joins the individual sensor samples (e.g., 2241-a) included in the validated sensor data 228-1 and forms a trajectory 226-1 using information from the location database 124. In particular, the trajectory generator 2233 matches RSSIs from the sensor data 224-1 to wireless APs in the location database 124 and form a trajectory using the inertial measurements and location of the wireless APs in the location database. For example, fingerprint matching between RSSIs of the validated sensor data 228-1 and the location database 124 provide anchor points in terms of where each individual RSSI scan might have happened. In some examples, the degree to which RSSI information is matched in the location database 124 can be adjusted by adjusting a fingerprint-matching threshold. The trajectory generator 2233 further determines the trajectory 226-1 based on the inertial measurements in the validated sensor data 228-1 and optionally the layout or floor plan for the indoor space in which the sensor data 224-1 is collected. In some examples, the trajectory generator 2233 may generate the trajectory by applying a sequential Monte Carlo (SMC) sampling method to the validated sensor data 228-1 to align the sensor data with the database and form the trajectories.

It is important to note, as indicated above, the update server 100 may generate the trajectory 226 instead of the computing devices 200-a. In some examples, the update server 100 may be configured to generate some of the trajectories 226-a (e.g., 226-1, 226-2) while ones of the computing devices 200-a generate the other trajectories 226-a (e.g., 226-3). In particular, the computing devices 200-a having sufficient computational power to generate the trajectories may do so while the computing devices 200-a lacking sufficient computation power may offload the generation of the trajectories to the update server 100.

Turning more specifically to FIG. 5, the update server 100 is shown. The control routine 122 may include a trajectory filterer 1221, a trajectory consistency checker 1222, and a location signature database updater 1223. In general, the control routine 122 receives the validated sensor data 228 and the trajectories 226 from the computing devices 200-a and updates the location database 124 based on the received validated sensor data 228 and trajectories 226.

The trajectory filterer 1221 may be configured to filter the validated sensor data 228 and trajectories 226 to ensure that the data used to update the location database is of good quality. In particular, the trajectory filterer 1221 may be configured to filter the validated sensor data 228 and/or the trajectories 226 based on a variety of different constraints.

The trajectory filterer 1221 may filter the trajectories 226 based on physical boundary constraints. More specifically, the trajectory filterer 1221 may filter the trajectories 226 based on the physical attributes of the indoor space to which the trajectories correspond. For example, trajectories that move through walls or locations of an RSSI scan determined to be located within a wall are physically unreasonable. The trajectory filter 1221 may be configured to remove those trajectories that are determined to be physically unreasonable.

The trajectory filterer 1221 may filter the trajectories 226 based on capability constraints or changes in position. The trajectory filterer 1221 can determine the velocity of the trajectories 226 and filter those trajectories whose velocity is unreasonable (e.g., exceeds a speed humans tend to walk, or the like). For example, the trajectory filterer 1221 may remove those trajectories with a velocity greater than 3 m/s.

The trajectory filterer 1221 may filter the trajectories 226 based on smoothness constraints or changes in velocity. The trajectory filterer 1221 can determine the acceleration (e.g., linear, angular, or the like) and filter those trajectories whose acceleration is unreasonable (e.g., exceeds an acceleration typical for human behavior).

The trajectory consistency checker 1222 may determine whether the various sensor data (e.g., from different computing device 200-a, the same computing device 200-a, or the like) are consistent with each other. For example, two sensor data “events” 224-a, one occurring before and one after the location change of a wireless AP may contradict with each other. In such an example, it is difficult to determine which sensor data “event” or which trajectory is correct. As such, the trajectory consistency checker is configured to check the consistency of the validated sensor data 228 and trajectories 226 based on a temporal continuity and a spatial continuity.

In general, temporal continuity is defined over a moving time window. All sensor data (e.g., particularly RSSI data) within the time window is checked against each other. Specifically, all RSSI data occurring at the same estimated location or within a specific range of each other (e.g. 1 meter, or the like) and corresponding to the same wireless AP is checked to determine that they have less than a threshold level of variation within the time window.

For example, the trajectory consistency checker 1222 can be configured to identify ones of the plurality of RSSIs (e.g., the RSSIs represented in the validated sensor data 228 and trajectories 226) occurring within a time window and within a threshold range of each other and to determine whether the difference between the identified RSSIs corresponding to the same wireless AP is less than a threshold level and to add the trajectory corresponding to the identified RSSIs to the set of consistent trajectories 126 based on the determination that the difference between the identified RSSIs corresponding to the same wireless access point is less than a threshold level.

In some examples, the threshold range is between 0.5 and 5 meters. In some examples, the threshold level is between 2 and 24 decibels per meter. In some examples, the time window is a moving time window having a duration of between 20 and 90 minutes.

In general, spatial continuity is defined over a radius of physical spaces. More particularly, validated sensor data 228 (e.g., particularly all RSSI data) within a physical space is check against each other. Specifically, all RSSI data occurring at the same time (e.g., within 1 hour of each other, or the like) within the physical space (e.g., a radius of each other, or the like) and corresponding to the same wireless AP are checked to determine that there is less than a threshold level of variation between the RSSIs.

For example, the trajectory consistency checker 1222 can be configured to identify ones of the plurality of RSSIs (e.g., the RSSIs represented in the validated sensor data 228 and trajectories 226) occurring within a threshold time of each other and within a threshold distance of each other and to determine whether the difference between the identified RSSIs corresponding to the same wireless AP is less than a threshold level. The trajectory consistency checker 1222 to add the trajectory corresponding to the identified RSSIs to the set of consistent trajectories 126 based on the determination that the difference between the identified RSSIs corresponding to the same wireless access point is less than a threshold level.

In some examples, the threshold distance is between 0.5 and 5 meters. In some examples, the threshold level is between 2 and 24 decibels per meter. In some examples, the threshold time is between 20 and 240 minutes.

The location signature database updater 1223 may be configured to generate the updated location database 128 from the location database 124 and the consistent trajectories 126. In general, the location signature database updater 1223 updates the location signature database 124 based on the set of consistent trajectories 126. In particular, the location signature database updater 1223 removes wireless APs from the location signature database 124 that conflict with the set of consistent trajectories 126 and generates the updated location database 128 from the remaining wireless APs in the location database 124 and the consistent trajectories 126.

In particular, the location signature database updater 1223 determines whether the wireless APs represented in the location database 124 are consistent with the wireless APs represented in the consistent trajectories 126. For example, location signature database updater 1223 can determine the wireless APs in the location signature database that are inconsistent with the wireless APs represented in the consistent trajectories 126 based on a temporal and/or spatial continuity, such as, for example, the temporal and spatial continuity described above. In general, where the location signature database updater 1223 determines that the location of a wireless AP in the location database 124 is not consistent with the location of the wireless AP represented in the consistent trajectories 126, it implies the wireless AP data in location database 124 is outdated. As a result, the location signature database updated 1223 may removed the wireless AP data from the location database 124.

Once wireless APs in the location database 124 that are consistent with the consistent trajectories 126 is determined, the location signature database updater 1223 may aggregate the consistent trajectories 126 with the wireless AP remaining the location database 124 (e.g., after the inconsistent wireless APs are removed, or the like). In some examples, the updater 1223 may apply a simultaneous localization and mapping (SLAM) algorithm to update the location database.

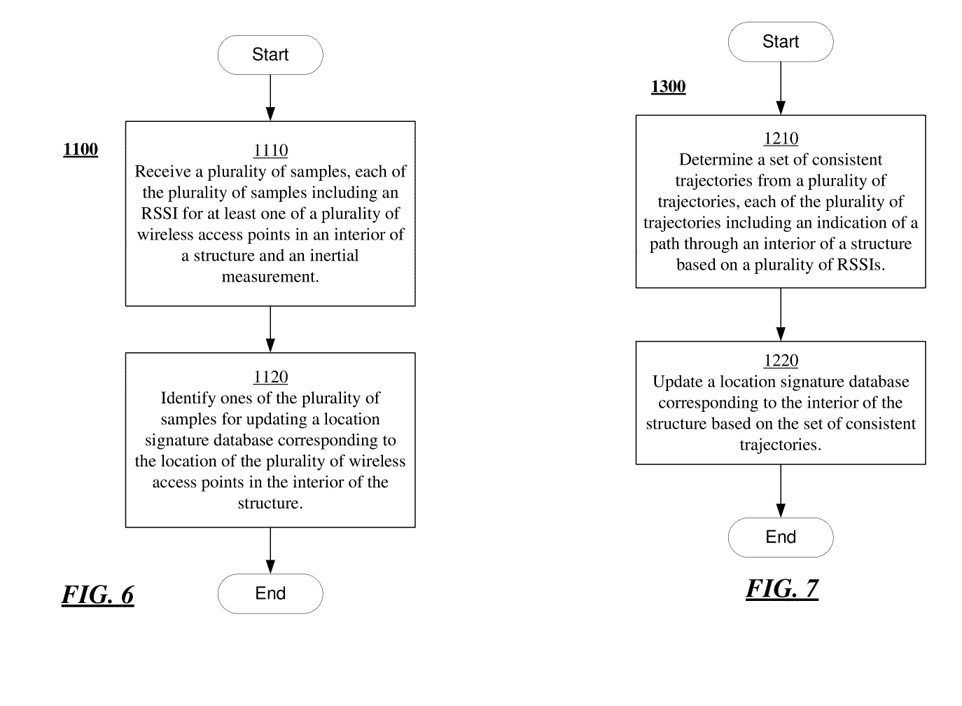

FIGS. 6-7 illustrate examples of logic flows representative of at least some operations executed by one or more logic, features, or devices described herein. In general, the logic flows may be representative of some of all of the operations executed by logic and/or features of the update server 100 and/or the computing devices 200-a of the system 1000. In particular, FIG. 6 may be representative of operations performed by the computing devices 200-1 in collecting sensor data 224-a, validating the sensor data 224-a, and generating trajectories 226-a while FIG. 7 may be representative of operations performed by the update server 100 in generating the updated location database 128. It is to be appreciated, that although the example logic flows are described with reference to the system 1000 of FIGS. 1-5, examples are not limited in this context.

Turning more specifically to FIG. 6, a logic flow 1100 is depicted. The logic flow 1100 may begin at block 1110. At block 1110, “receive a plurality of samples, each of the plurality of samples including an RSSI for at least one of a plurality of wireless access points in an interior of a structure and an inertial measurement” the computing device 200-a may receive the sensor data 224-a (e.g., comprising samples 224a-b, or the like). For example, the sensor data sample collector 223a may receive signals from the sensor 230-1 indicating at least an number of RSSI scans and inertial measurements.

Continuing to block 1120, “identify ones of the plurality of samples for updating a location signature database corresponding to the location of the plurality of wireless access points in the interior of the structure” the computing device 200-a may identify portions (e.g., samples within, or the like) of the sensor data 224-1 to be used to update the location database 124. For example, the sensor data validator 2232 may determine the validated sensor data 228-1 to be used to generate the trajectory 226-1 and ultimately update the location database 124.

Turning more specifically to FIG. 7, a logic flow 1200 is depicted. The logic flow 1200 may begin at block 1210. At block 1210, “determine a set of consistent trajectories from a plurality of trajectories, each of the plurality of trajectories including an indication of a path through an interior of a structure based on a plurality of RSSIs” the update server 100 may determine the set of consistent trajectories 126 from the trajectories 226 and the validated sensor data 228. In particular, the trajectory consistency checker 1221 may determine ones of the trajectories 226 that are consistent (e.g., conform to specified human behavioral limits, consistent with the interior of the structure, or the like).

Continuing to block 1220, “update a location signature database corresponding to the interior of the structure based on the set of consistent trajectories” the update server 100 may generate the updated location signature database from the consistent trajectories 126 and the location database 124. In particular, the location signature database updater 1223 may generate the updated location database 128 from the location database 124 and the consistent trajectories by applying a SLAM algorithm to the locations of the wireless APs in the consistent trajectories 126 and the location database 124.

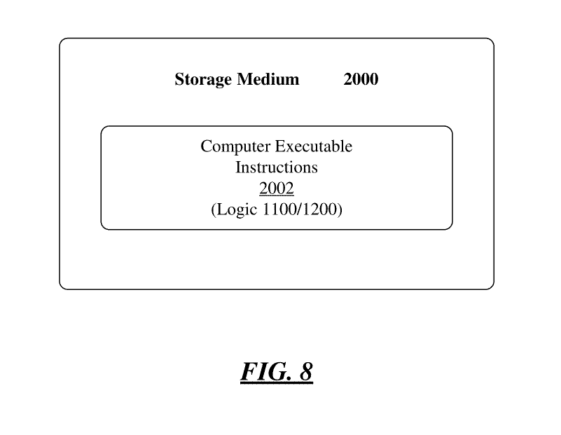

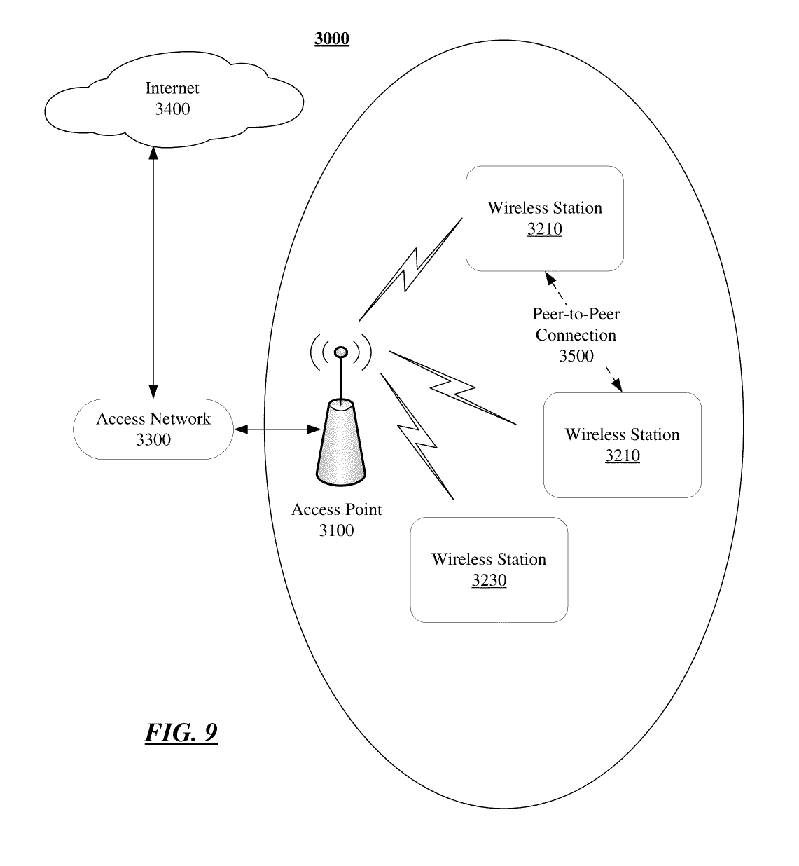

FIG. 8 illustrates an embodiment of a storage medium 2000. The storage medium 2000 may comprise an article of manufacture. In some examples, the storage medium 2000 may include any non-transitory computer readable medium or machine readable medium, such as an optical, magnetic or semiconductor storage. The storage medium 2000 may store various types of computer executable instructions e.g., 2002). For example, the storage medium 2000 may store various types of computer executable instructions to implement logic flow 1100. In some examples, the storage medium 2000 may store various types of computer executable instructions to implement logic flow 1200.

Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

FIG. 9 illustrates an embodiment of a wireless network 3000. As shown in FIG. 9, wireless network 3000 comprises an access point 3100 and wireless stations 3210, 3220, and 3230. In various embodiments, wireless network 3000 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 3000 may comprise another type of wireless network, and/or may implement other wireless communications standards. In various embodiments, for example, wireless network 3000 may comprise a WWAN or WPAN rather than a WLAN. The embodiments are not limited to this example. Furthermore, it is to be appreciated that more than one access point 3100 (e.g., refer to FIG. 2) may be provided. However, only a single access point is shown in FIG. 9 for purposes of clarity.

In various embodiments, wireless stations 3210, 3220, and 3230 may communicate through access point 3100 in order to obtain connectivity to one or more external data networks. In some embodiments, for example, wireless stations 3210, 3220, and 3230 may connect to the Internet 3400 via access point 3100 and access network 3300. In various embodiments, access network 3300 may comprise a private network that provides subscription-based Internet-connectivity, such as an Internet Service Provider (ISP) network. The embodiments are not limited to this example.

In various embodiments, two or more of wireless stations 3210, 3220, and 3230 may communicate with each other directly and/or through access point 3100 in order to obtain P2P connectivity and service capabilities and network connectivity capability information for the purpose of exchanging peer-to-peer communications. For example, as depicted in FIG. 9, wireless stations 3210 and 3220 communicate with each other directly by exchanging peer-to-peer communications 3500. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. In various embodiments, such peer-to-peer communications may be performed according to the MFA NAN protocol. The embodiments are not limited to these examples.

Various examples described herein may be provided to enable one or more of the wireless stations (e.g., the station 3210) to provide location data, including an indication of a path of the wireless station through an interior of a structure (e.g., a structure housing the wireless access point 3100) to an update server (not shown). For example, the wireless station may connect to the update server via the Internet 3400 to provide location data to the update server and/or to receive an updated location database (e.g., the updated location database 128) from the update server.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose might be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

### Example 1

An apparatus to update a wireless location database, the apparatus including a processing component; a trajectory consistency checker for execution by the processing component, the trajectory consistency checker to determine a set of consistent trajectories from a plurality of trajectories, each of the plurality of trajectories including an indication of a path through an interior of a structure based on a plurality of signal indicators, each of the plurality of signal indicators corresponding to one of a plurality a wireless access points in the interior of the structure; and a location signature database updater for execution by the processing component, the location signature database updater to update a location signature database corresponding to the interior of the structure based on the set of consistent trajectories, the location signature database including indications of a location of the plurality of wireless access points within the interior of the structure.

### Example 2

The apparatus of example 1, wherein the trajectory is based on the plurality of signal indicators and a plurality of inertial measurements.

### Example 3

The apparatus of example 2, the trajectory consistency checker to identify ones of the plurality of signal indicators occurring within a time window and within a threshold range of each other, the trajectory consistency checker to determine whether the difference between the identified signal indicators corresponding to the same wireless access point is less than a threshold level and to add the trajectory corresponding to the identified signal indicators to the set of consistent trajectories based on the determination that the difference between the identified signal indicators corresponding to the same wireless access point is less than a threshold level.

### Example 4

The apparatus of example 3, wherein the threshold range is between 0.5 and 5 meters.

### Example 5

The apparatus of example 3, wherein the threshold level is between 2 and 24 decibels per meter.

### Example 6

The apparatus of example 3, wherein the time window is a moving time window having a duration of between 20 and 90 minutes.

### Example 7

The apparatus of example 2, the trajectory consistency checker to identify ones of the plurality of signal indicators occurring within a threshold time of each other and within a threshold distance of each other, the trajectory consistency checker to determine whether the difference between the identified signal indicators corresponding to the same wireless access point is less than a threshold level and to add the trajectory corresponding to the identified signal indicators to the set of consistent trajectories based on the determination that the difference between the identified signal indicators corresponding to the same wireless access point is less than a threshold level.

### Example 8

The apparatus of example 7, wherein the threshold distance is between 0.5 and 5 meters.

### Example 9

The apparatus of example 7, wherein the threshold level is between 2 and 24 decibels per meter.

### Example 10

The apparatus of example 7, wherein the threshold time is between 20 and 240 minutes.

### Example 11

The apparatus of example 2, comprising a trajectory filterer for execution by the processing component, for each of the plurality of trajectories, the trajectory filterer to determine whether the trajectory is consistent with the interior of the structure and to remove the trajectory from the plurality of trajectories based on the determination that the trajectory is not consistent with the interior of the structure.

### Example 12

The apparatus of example 11, the trajectory filterer to determine whether the trajectory is within one or more known pathways in the interior of the structure.

### Example 13

The apparatus of example 12, comprising a trajectory filterer for execution by the processing component, for each of the plurality of trajectories, the trajectory filterer to determine whether a velocity of the trajectory is less than a threshold velocity and to remove the trajectory from the plurality of trajectories based on the determination that the velocity of the trajectory is not less than the threshold velocity.

### Example 14

The apparatus of example 12, wherein the threshold velocity is between 1 and 5 meters per second.

### Example 15

The apparatus of example 2, comprising a trajectory filterer for execution by the processing component, for each of the plurality of trajectories, the trajectory filterer to determine whether an acceleration of the trajectory is less than a threshold acceleration and to remove the trajectory from the plurality of trajectories based on the determination that the acceleration of the trajectory is not less than the threshold acceleration.

### Example 16

The apparatus of example 15, wherein the threshold acceleration is between 2 and 25 meters per second squared.

### Example 17

The apparatus of example 2, the location signature database updater to determine a set of consistent wireless access points based on the set of consistent trajectories and the location of the wireless access points in the location signature database.

### Example 18

The apparatus of example 17, the location signature updater to update the location signature database based in part on a simultaneous localization and mapping (SLAM) optimization.

### Example 19

The apparatus of example 2, the location signature updater to communicate the updated location signature database to one or more client computing devices.

### Example 20

The apparatus of any one of examples 1 to 19, wherein the signal indicators are selected from the group consisting of received signal strength indicators and signal to noise ratios.

### Example 21

The apparatus of any one of examples 1 to 19, comprising a network interface operably coupled to the processing component or operably coupled to the location database updater, the network interface to receive the plurality of trajectories or the location database updater to communicate the updated location database to one or more client computing devices via the network interface.

### Example 22

An apparatus for updating a location signature database, the apparatus including a processing component; a sensor sample collector for execution by the processing component, the sensor sample collector to receive a plurality of samples, each of the plurality of samples including a signal indicators for at least one of a plurality of wireless access points in an interior of a structure and an inertial measurement; and a sensor data validator for execution by the processing component, the sensor data validator to identify ones of the plurality of samples for updating a location signature database corresponding to the location of the plurality of wireless access points in the interior of the structure.

### Example 23

The apparatus of example 22, the sensor data validator to determine whether ones of the plurality of signal indicators are within a specific range and identify the ones of the plurality of signal indicators for updating the location signature database based on the determination that the ones of the plurality of signal indicators are within the specific range.

### Example 24

The apparatus of example 22, comprising a trajectory generator for execution by the processing component, the trajectory generator to generate a trajectory, the trajectory including an indication of a path through the interior of the structure based on the plurality of signal indicators and the plurality of inertial measurements.

### Example 25

The apparatus of example 24, the location signature database including an indication of the location of the plurality of wireless access points, the trajectory generator to generate the trajectory based on matching the signal indicators to the location of the plurality of wireless access points.

### Example 26

The apparatus of example 25, the trajectory to match the signal indicators to the location of the plurality of wireless access points based on a sequential Monte Carlo analysis.

### Example 27

The apparatus of example 26, further comprising a sensor data filterer for execution by the processing component, the sensor data filterer to determine ones of the plurality of samples are consistent with the interior of the structure and to identify the ones of the plurality of samples for updating the location signature database based on the determination that the ones of the plurality of samples are consistent with the interior of the structure.

### Example 28

The apparatus of any one of examples 22 to 27, comprising an antenna and a radio operably connected to the antenna, the radio to receive a wireless signal, the wireless signal corresponding to at least one of the signal indicators.

### Example 29

The apparatus of any one of examples 22 to 27, comprising one or more of an accelerometer, a gyroscope, or a magnetic sensor, the plurality of inertial measurements corresponding to indications of inertial movement from the accelerometer, the gyroscope, or the magnetic sensor.

### Example 30

The apparatus of any one of examples 22 to 27, wherein the signal indicators are selected from the group consisting of received signal strength indicators and signal to noise ratios.

### Example 31

A method implemented by a wireless fingering database update server, the method including determining a set of consistent trajectories from a plurality of trajectories, each of the plurality of trajectories including an indication of a path through an interior of a structure based on a plurality of signal indicators, each of the plurality of signal indicators corresponding to one of a plurality a wireless access point in the interior of the structure and an inertial measurement; and updating a location signature database corresponding to the interior of the structure based on the set of consistent trajectories, the location signature database including indications of a location of the plurality of wireless access points within the interior of the structure.

### Example 32

The method of example 31, comprising: identifying ones of the plurality of signal indicators occurring within a time window and within a threshold range of each other; determining whether the difference between the identified signal indicators corresponding to the same wireless access point is less than a threshold level; and adding the trajectory corresponding to the identified signal indicators to the set of consistent trajectories based on the determination that the difference between the identified signal indicators corresponding to the same wireless access point is less than a threshold level.

### Example 33

The method of example 32, wherein the threshold range is between 0.5 and 5 meters.

### Example 34

The method of example 32, wherein the threshold level is between 2 and 24 decibels per meter.

### Example 35

The method of example 32, wherein the time window is a moving time window having a duration of between 20 and 90 minutes.

### Example 36

The method of example 32, comprising: identifying ones of the plurality of signal indicators occurring within a threshold time of each other and within a threshold distance of each other; determining whether the difference between the identified signal indicators corresponding to the same wireless access point is less than a threshold level; and adding the trajectory corresponding to the identified signal indicators to the set of consistent trajectories based on the determination that the difference between the identified signal indicators corresponding to the same wireless access point is less than a threshold level.

### Example 37

The method of example 36, wherein the threshold distance is between 0.5 and 5 meters.

### Example 38

The method of example 36, wherein the threshold level is between 2 and 24 decibels per meter.

### Example 39

The method of example 36, wherein the threshold time is between 20 and 240 minutes.

### Example 40

The method of example 32, comprising: determining, for each of the plurality of trajectories, whether the trajectory is consistent with the interior of the structure; and removing the trajectory from the plurality of trajectories based on the determination that the trajectory is not consistent with the interior of the structure.

### Example 41

The method of example 40, comprising determining whether the trajectory is within one or more known pathways in the interior of the structure.

### Example 42

The method of example 41, comprising: determining, for each of the plurality of trajectories, whether a velocity of the trajectory is less than a threshold velocity; and removing the trajectory from the plurality of trajectories based on the determination that the velocity of the trajectory is not less than the threshold velocity.

### Example 43

The method of example 42, wherein the threshold velocity is between 1 and 5 meters per second.

### Example 44

The method of example 32, comprising: determining, for each of the plurality of trajectories, whether an acceleration of the trajectory is less than a threshold acceleration; and removing the trajectory from the plurality of trajectories based on the determination that the acceleration of the trajectory is not less than the threshold acceleration.

### Example 45

The method of example 44, wherein the threshold acceleration is between 2 and 25 meters per second squared.

### Example 46

The method of example 32, comprising determining a set of consistent wireless access points based on the set of consistent trajectories and the location of the wireless access points in the location signature database.

### Example 47

The method of example 46, comprising updating the location signature database based in part on a simultaneous localization and mapping (SLAM) optimization.

### Example 48

The method of example 32, comprising communicating the updated location signature database to one or more client computing devices.

### Example 49

The method of any one of examples 31 to 48, wherein the signal indicators are selected from the group consisting of received signal strength indicators and signal to noise ratios.

### Example 50

A method implemented by a computing device in a wireless fingerprint location database update system, the method including receiving a plurality of samples, each of the plurality of samples including a signal indicator for at least one of a plurality of wireless access points in an interior of a structure and an inertial measurement; and identifying ones of the plurality of samples for updating a location signature database corresponding to the location of the plurality of wireless access points in the interior of the structure.

### Example 51

The method of example 50, the sensor data validator to determine whether ones of the plurality of signal indicators are within a specific range and identify the ones of the plurality of signal indicators for updating the location signature database based on the determination that the ones of the plurality of signal indicators are within the specific range.

### Example 52

The apparatus of example 50, comprising generating a trajectory, the trajectory including an indication of a path through the interior of the structure based on the plurality of signal indicators and the plurality of inertial measurements.

### Example 53

The method of example 52, the location signature database including an indication of the location of the plurality of wireless access points, the method comprising generating the trajectory based on matching the signal indicators to the location of the plurality of wireless access points.

### Example 54

The method of example 53, the trajectory to match the signal indicators to the location of the plurality of wireless access points based on a sequential Monte Carlo analysis.

### Example 55

The apparatus of example 54, comprising: determining ones of the plurality of samples are consistent with the interior of the structure; and identifying the ones of the plurality of samples for updating the location signature database based on the determination that the ones of the plurality of samples are consistent with the interior of the structure.

### Example 56

The method of any one of examples 50 to 55, comprising receiving a wireless signal, the wireless signal corresponding to at least one of the signal indicators.

### Example 57

The method of any one of examples 50 to 55, wherein the plurality of inertial measurements correspond to indications of inertial movement received from one or more of an accelerometer, a gyroscope, or a magnetic sensor.

### Example 58

The method any one of examples 50 to 55, wherein the signal indicators are selected from the group consisting of received signal strength indicators and signal to noise ratios.

### Example 59

An apparatus for a device in a wireless network, the apparatus comprising means to perform the method of any of examples 31 to 58.

### Example 60

At least one machine readable medium comprising a plurality of instructions that in response to being executed on a component in a wireless fingerprint location database update system cause the component to perform the method of any of examples 31 to 58.

### Example 61

An apparatus for a wireless network including a processor; a radio operably connected to the processor; one or more antennas operably connected to the radio to transmit or receive wireless signals; and a memory comprising a plurality of instructions that in response to being executed by the processor cause the processor or the radio to perform the method of any of examples 31 to 58.

1. An apparatus to update a wireless location database, the apparatus comprising:
a processing component;
a trajectory consistency checker for execution by the processing component, the trajectory consistency checker to determine a set of consistent trajectories from a plurality of trajectories, each of the plurality of trajectories including an indication of a path through an interior of a structure based on a plurality of signal indicators, each of the plurality of signal indicators corresponding to one of a plurality a wireless access point in the interior of the structure; and
a location signature database updater for execution by the processing component, the location signature database updater to update a location signature database corresponding to the interior of the structure based on the set of consistent trajectories, the location signature database including indications of a location of the plurality of wireless access points within the interior of the structure.

2. The apparatus of claim 1, wherein the trajectory is based on the plurality of signal indicators and a plurality of inertial measurements.

3. The apparatus of claim 2, wherein the plurality of signal indicators are selected from the group consisting of received signal strength indicators and signal to noise ratios.

4. The apparatus of claim 2, the trajectory consistency checker to identify ones of the plurality of signal indicators occurring within a time window and within a threshold range of each other, the trajectory consistency checker to determine whether the difference between the identified signal indicators corresponding to the same wireless access point is less than a threshold level and to add the trajectory corresponding to the identified signal indicators to the set of consistent trajectories based on the determination that the difference between the identified signal indicators corresponding to the same wireless access point is less than a threshold level.

5. The apparatus of claim 2, the trajectory consistency checker to identify ones of the plurality of signal indicators occurring within a threshold time of each other and within a threshold distance of each other, the trajectory consistency checker to determine whether the difference between the identified signal indicators corresponding to the same wireless access point is less than a threshold level and to add the trajectory corresponding to the identified signal indicators to the set of consistent trajectories based on the determination that the difference between the identified signal indicators corresponding to the same wireless access point is less than a threshold level.

6. The apparatus of claim 2, comprising a trajectory filterer for execution by the processing component, for each of the plurality of trajectories, the trajectory filterer to determine whether the trajectory is consistent with the interior of the structure and to remove the trajectory from the plurality of trajectories based on the determination that the trajectory is not consistent with the interior of the structure.

7. The apparatus of claim 6, comprising a trajectory filterer for execution by the processing component, for each of the plurality of trajectories, the trajectory filterer to determine whether a velocity of the trajectory is less than a threshold velocity and to remove the trajectory from the plurality of trajectories based on the determination that the velocity of the trajectory is not less than the threshold velocity.

8. The apparatus of claim 6, wherein the threshold velocity is between 1 and 5 meters per second.

9. The apparatus of claim 2, comprising a trajectory filterer for execution by the processing component, for each of the plurality of trajectories, the trajectory filterer to determine whether an acceleration of the trajectory is less than a threshold acceleration and to remove the trajectory from the plurality of trajectories based on the determination that the acceleration of the trajectory is not less than the threshold acceleration.

10. The apparatus of claim 2, the location signature database updater to determine a set of consistent wireless access points based on the set of consistent trajectories and the location of the wireless access points in the location signature database.

11. The apparatus of claim 17, the location signature updater to update the location signature database based in part on a simultaneous localization and mapping (SLAM) optimization.

12. The apparatus of claim 2, comprising a network interface operably coupled to the location signature updater, the location signature updater to communicate the updated location signature database to one or more client computing devices via the network interface.

13. An apparatus for updating a location signature database, the apparatus comprising:
a processing component;
a sensor sample collector for execution by the processing component, the sensor sample collector to receive a plurality of samples, each of the plurality of samples including a signal indicator for at least one of a plurality of wireless access points in an interior of a structure and an inertial measurement; and
a sensor data validator for execution by the processing component, the sensor data validator to identify ones of the plurality of samples for updating a location signature database corresponding to the location of the plurality of wireless access points in the interior of the structure.

14. The apparatus of claim 13, the sensor data validator to determine whether ones of the plurality of signal indicators are within a specific range and identify the ones of the plurality of signal indicators for updating the location signature database based on the determination that the ones of the plurality of signal indicators are within the specific range.

15. The apparatus of claim 13, comprising a trajectory generator for execution by the processing component, the trajectory generator to generate a trajectory, the trajectory including an indication of a path through the interior of the structure based on the plurality of signal indicators and the plurality of inertial measurements.

16. The apparatus of claim 15, the location signature database including an indication of the location of the plurality of wireless access points, the trajectory generator to generate the trajectory based on matching the signal indicators to the location of the plurality of wireless access points.

17. The apparatus of claim 13, further comprising a sensor data filterer for execution by the processing component, the sensor data filterer to determine ones of the plurality of samples are consistent with the interior of the structure and to identify the ones of the plurality of samples for updating the location signature database based on the determination that the ones of the plurality of samples are consistent with the interior of the structure.

18. The apparatus of claim 13, comprising one or more of an accelerometer, a gyroscope, or a magnetic sensor, the plurality of inertial measurements corresponding to indications of inertial movement from the accelerometer, the gyroscope, or the magnetic sensor.

19. The apparatus of claim 13, comprising an antenna and a radio operably connected to the antenna, the radio to receive a wireless signal, the wireless signal corresponding to at least one of the signal indicators.

20. A method implemented by a wireless fingering database update server, the method comprising:
determining a set of consistent trajectories from a plurality of trajectories, each of the plurality of trajectories including an indication of a path through an interior of a structure based on a plurality of signal indicators, each of the plurality of signal indicators corresponding to one of a plurality a wireless access point in the interior of the structure and an inertial measurement; and
updating a location signature database corresponding to the interior of the structure based on the set of consistent trajectories, the location signature database including indications of a location of the plurality of wireless access points within the interior of the structure.

21. The method of claim 20, comprising:
identifying ones of the plurality of signal indicators occurring within a time window and within a threshold range of each other;
determining whether the difference between the identified signal indicators corresponding to the same wireless access point is less than a threshold level; and
adding the trajectory corresponding to the identified signal indicators to the set of consistent trajectories based on the determination that the difference between the identified signal indicators corresponding to the same wireless access point is less than a threshold level.

22. The method of claim 21, comprising determining a set of consistent wireless access points based on the set of consistent trajectories and the location of the wireless access points in the location signature database.

23. At least one machine readable medium comprising a plurality of instructions that in response to being executed on a computing device cause the computing device to:
receiving a plurality of samples, each of the plurality of samples including a signal indicator for at least one of a plurality of wireless access points in an interior of a structure and an inertial measurement; and
identifying ones of the plurality of samples for updating a location signature database corresponding to the location of the plurality of wireless access points in the interior of the structure.

24. The at least one machine readable medium of claim 23, the instructions further causing the computing device to determine whether ones of the plurality of signal indicators are within a specific range and identify the ones of the plurality of signal indicators for updating the location signature database based on the determination that the ones of the plurality of signal indicators are within the specific range.

25. The at least one machine readable medium of claim 24, the instructions further causing the computing device to generate a trajectory, the trajectory including an indication of a path through the interior of the structure based on the plurality of signal indicators and the plurality of inertial measurements.
